(19) United States
(12) Patent Application Publication
(10) Pub. No.: US 2006/0081625 A1
(43) Pub. Date: Apr. 20, 2006

(54) Food packaging for microwave pressure cooking and method of using same

(75) Inventor: William A. Skaife, San Marcos, CA (US)

Correspondence Address: MCKEE, VOORHEES & SEASE, P.L.C., 801 GRAND AVENUE, SUITE 3200, DES MOINES, IA, 50309-2721, US

(73) Assignee: THE VIVIAN A. SKAIFE TRUST, San Marcos, CA (US)

(21) Appl. No.: 10/955,186

(22) Filed: Sep. 30, 2004

Related U.S. Application Data
(63) Continuation-in-part of application No. 10/269,455, filed on Oct. 11, 2002.

(51) Int. Cl. H05B 6/80

(52) U.S. Cl. 219/725

(57) ABSTRACT

Food packaging includes a top wall of film plastic material which in turn includes top and bottom wall portions creating a pocket therebetween. The pocket bottom wall portion has feed openings communicating with the food chamber. The top wall portion includes a centrally disposed feed opening registering with a vent opening in the bottom wall portion with the bottom wall feed openings being remotely located and adapted to be sealed during cooking by pressure within the food chamber pressing the bottom wall portion against the top wall portion.

### CROSS-REFERENCE TO RELATED APPLICATIONS

This application is a Continuation-in-part of application Ser. No. 10/269,455 filed Oct. 11, 2002 of which is incorporated herein by reference.

### BACKGROUND OF THE INVENTION

This invention relates to packaging food for display in the market, preparing the food for cooking and then microwave cooking the food.

Typical preparation of food for microwaving involves removing food from packaging, placing it in a dish and then placing the dish in the microwave oven for cooking. What is needed is packaging and a method of microwave cooking that utilizes the best features of known cooking methods with the food packaging becoming a cooking vessel for pressure cooking in the microwave oven.

### SUMMARY OF THE INVENTION

Food is packaged in conventional plastic wrapping material but a liquid feed opening with a relief valve is provided in the top of the package. The top wall of the food package includes two wall portions with the top wall portion having a centrally located feed opening axially aligned with a vent opening in the lower wall portion. The lower wall portion includes a plurality of feed openings remotely positioned relative to the vent opening with one of the feed openings being substantially larger to allow passage of larger feed additives. All feed openings in the lower wall portion allow for passage of liquid including water and flavorings into the food chamber of the package.

Cooking of the food in the packaging creates steam which in turn presses the lower wall portion against the top wall portion thereby sealing all feed openings in the lower wall portion leaving the vent opening to allow release of a limited amount of gas pressure. The sides of the vent opening can be varied as required by the cooking circumstances. If a number of food items having different cooking times are to be cooked at the same time the size of the vent opening can be selected to effectively make the cooking time for all items substantially the same.

The top and bottom walls of the food package may vary between two film sheets to a top film sheet sealingly secured to the top edges of a tray. The tray may have the shape of a piece of pie and thus when a plurality of trays are positioned together they form a pie shape which in turn corresponds to the circular rotatable tray of a microwave oven.

The food packaging may also include a unitary tray having multiple food chambers. A further alternative is for a pair of film sheets being provided that are sealingly secured together along a plurality of radial lines and then around the peripheral edges after the food items have been inserted into each of the food chambers by the grocer or consumer.

The cooking method involves determining the cooking times of each of the food items to be cooked and setting the maximum time on the microwave oven. The food item requiring the longest cooking time is placed in the oven first and when the cooking time of the item requiring the second longest cooking time appears on the timer the second item is placed in the oven and the procedure is repeated until all items are cooked and the time on the timer has expired. This procedure provides a properly cooked entire meal in a minimum amount of time and with minimum effort.

Preparatory to placing the packaged food in the microwave oven, liquid and flavorings may be added to the food in the packaging through the feed opening in the top wall portion of the top wall wherein liquid travels through the feed openings in the bottom wall portion of the top wall thence into the food chamber with the food to be cooked.

During the microwave cooking, pressure in the packaging inflates the packaging causing gas to be formed which tightly presses the bottom wall portion of the top wall against the top wall portion of the top wall causing the substantial sealing of the feed openings in the bottom wall portion of the top wall to allow for limited pressure cooking. Excess pressure is relieved through the opening in the top wall portion of the top wall by gas escaping from the food chamber through the vent opening in the bottom wall portion of the top wall into the pocket between the top and bottom wall portions and thence out through the feed opening in the top wall portion of the top wall.

Preparatory to placing the packaged food in the microwave, liquid and flavorings may be added to the food in the packaging food chamber through the feed opening in the top wall portion wherein liquid travels through the feed openings in the pocket into the food chamber.

A variety of individually packaged food products may be appropriately packaged for simultaneous cooking in a microwave oven such that an entire meal may be cooked in one operation.

Precise cooking results can consistently be expected by maintaining a record of information including food weight, amount of liquid and flavoring added, cooking vessel used, microwave wattage and cooking time. Once the desired results have been obtained and the cooking information has been determined it may be expected that those same results can be replicated consistently thereafter.

### BRIEF DESCRIPTION OF THE DRAWINGS

FIG. 1 is a top perspective view of the food packaging of this invention containing cauliflower ready to be cooked.

FIG. 2 is a perspective view similar to FIG. 1 showing additives including liquid being added to the food chamber through the feed opening in the top wall.

FIG. 2A is a cross-sectional view taken along line 2A in FIG. 2 showing a bottom wall portion of the top wall being formed by a piece of patch film material secured to the bottom side of the top sheet.

FIG. 2B is a view similar to FIG. 2A but showing the piece of patch sheet material being attached to the top side of the top film sheet.

FIG. 3 is a view similar to FIG. 2 but showing the liquid being fed through the top feed opening into the pocket formed between the top and bottom wall portions of the top sheet thence into the large feed opening of the bottom wall portion of the top sheet.

FIG. 4 is a perspective view of the food package of FIG. 1 positioned in a microwave oven.

FIG. 5 is a cross-sectional view taken along line 5-5 in FIG. 4 showing the pressure cooking effect within the food chamber and pocket between the upper and lower wall portions of the upper wall.

FIG. 6 is a cross-sectional view taken along line 6-6 in FIG. 1 showing the feed openings in the lower wall portion of the top wall being sealed by the pressure created within the food chamber.

FIG. 7 is a top perspective view of food packaging including a pair of sheets of film material secured together along radial lines thereby forming a plurality of food chambers.

FIG. 8 is a top plan view thereof.

FIG. 9 is a top perspective view of a pie piece shaped food packaging tray.

FIG. 10 is a top plan view thereof.

FIG. 11 is a top perspective view of a pie piece shaped unitary tray having multiple food chambers.

FIG. 12 is a front perspective view of a plurality of pie piece food packages requiring different cooking times ready to be placed in the microwave oven.

FIG. 13 is a view similar to FIG. 12 showing the second step in the cooking method wherein the food item having the second longest cooking time is being placed in the microwave oven.

FIG. 14 is a view similar to FIGS. 12 and 13 but showing the last pie piece shape food package being inserted into the microwave oven.

FIG. 15 is a front exploded perspective view of a pie piece shaped tray having the top film sheet secured to the top edges of the tray side walls by downwardly facing U-shaped clips.

FIG. 16 is a top perspective view of the tray of FIG. 15 fully assembled.

### DETAILED DESCRIPTION OF THE PREFERRED EMBODIMENT

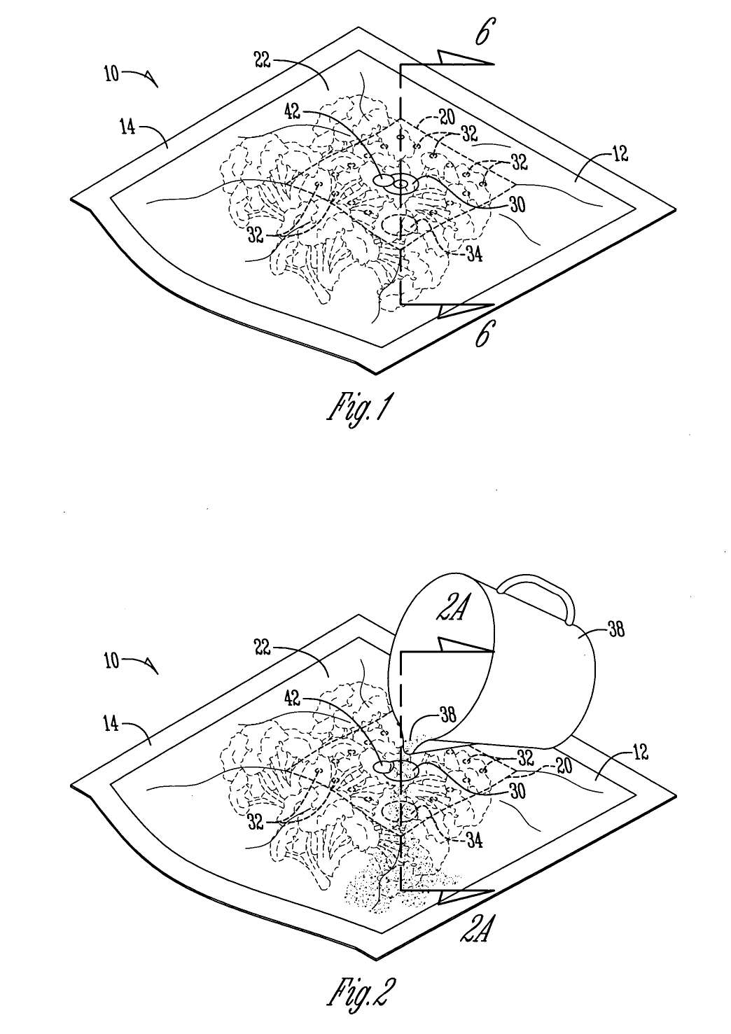

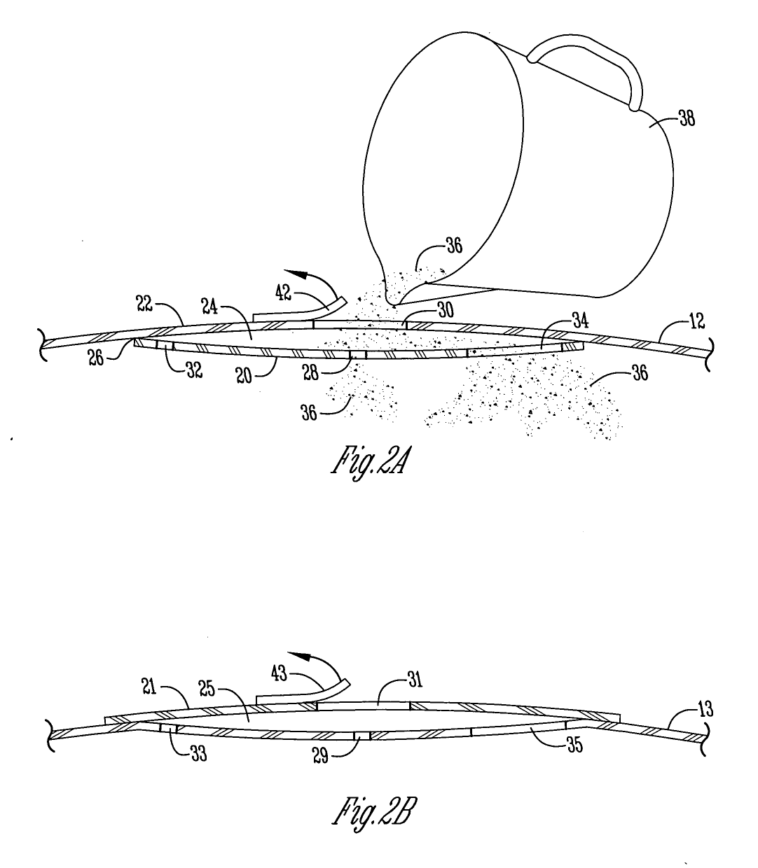

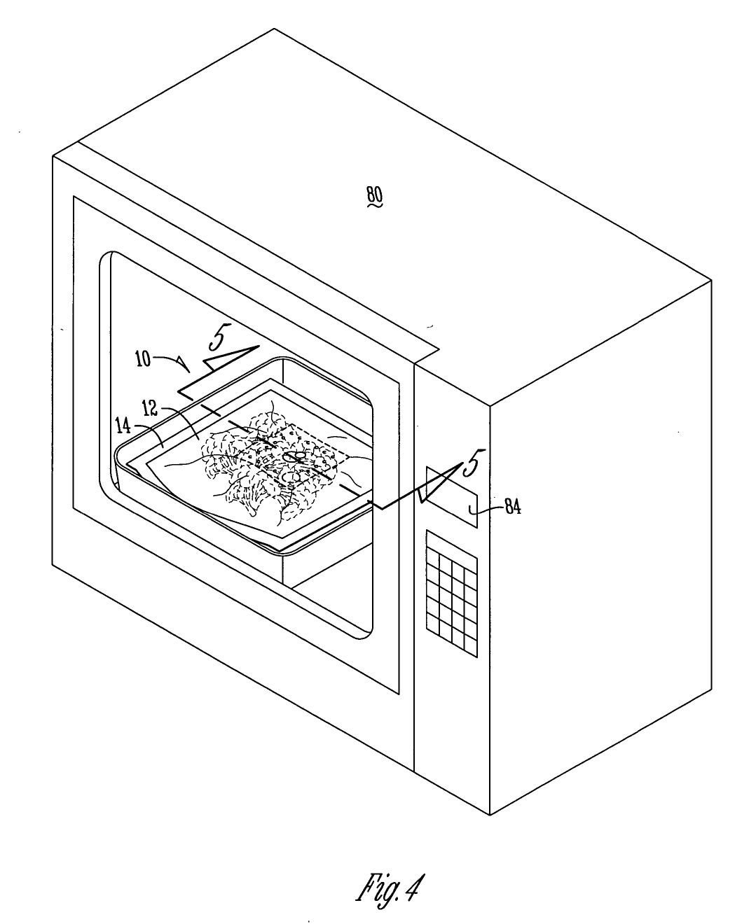

The food packaging of this invention is generally referred to in FIG. 1 by the reference numeral 10 and as seen in FIGS. 2A and 5 includes a top sheet of film 12 sealed at its peripheral edges 14 to a bottom sheet of film 16 creating a food chamber 18 therebetween.

The top sheet of film 12 includes a patch 20 forming a lower wall portion of the top sheet 12 including a top wall portion 22 creating therebetween a pocket 24. The patch or bottom wall portion 20 is sealed at 26 around its peripheral edge to the top sheet 12.

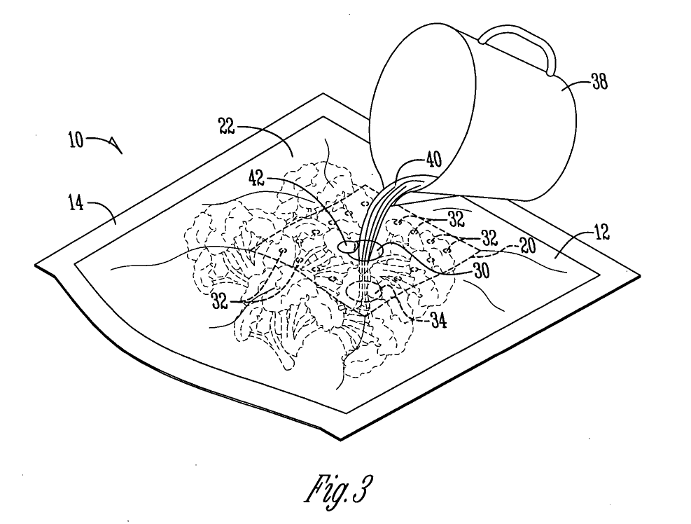

The bottom wall portion 20 includes a vent hole 28 centrally positioned and in vertical alignment with a fill hole 30 in the top wall portion 22. As seen in FIG. 1, a plurality of small fill holes 32 are provided around the periphery of the bottom wall portion 20 among which is a larger fill hole 34 all of which are remotely located relative to the centrally located vent hole 28. As seen in FIGS. 2, 2A and 3, flavoring additives 36 from a pitcher 38 are added through the fill hole 30 into the pocket 24 which in turn allows passageway through the fill holes 32 and 34 into the food chamber 18. It is seen that the large fill hole 34 will allow for larger size additives to be added to the food chamber 18.

The flow of liquid including water 40 is facilitated by lifting a tab 42 on the top wall portion 22 overlapping the fill hole 30 via an enlarged pocket 24.

In FIG. 2B an alternate embodiment of FIG. 2A is shown differing only in the placement of a patch 21 on the top side of the top packaging wall of film material 13 as opposed to the patch 20 in FIG. 2A being on the bottom side of the top film wall 12. In the embodiment of FIG. 2B the patch 21 includes the fill opening 31 in communication with a vent hole 29. Small fill openings 33 are provided in the bottom wall portion 23 along with a large fill opening 35.

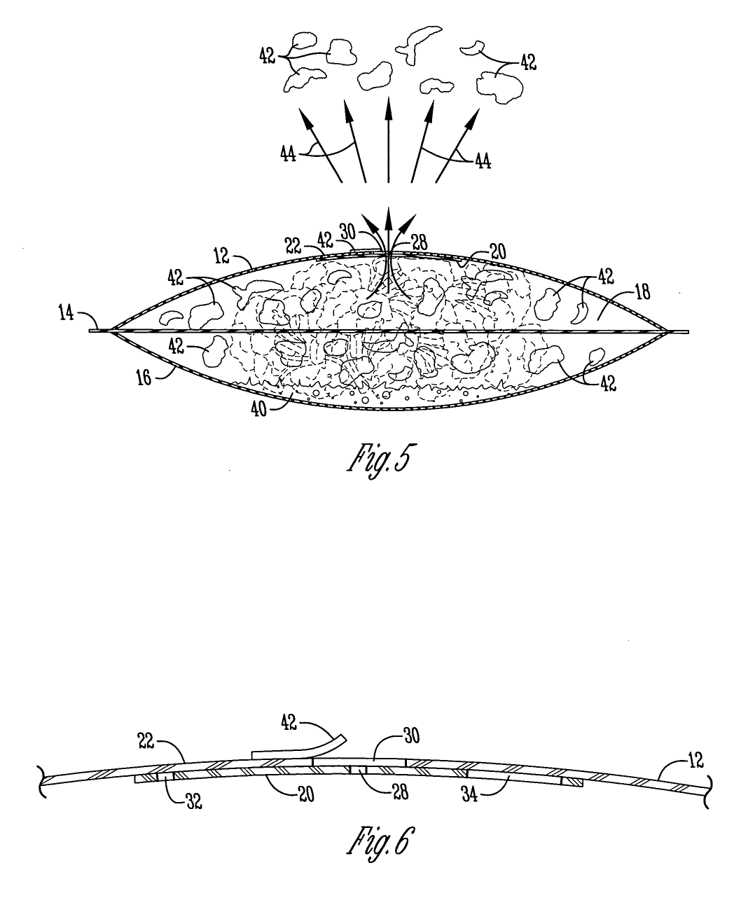

During the microwave cooking as seen in FIGS. 4-6, the heat generated inflates the food chamber 18 spreading the top sheet wall 12 from the bottom sheet wall 16 producing steam and vapor 42 which presses the bottom wall portion 20 against the top wall portion 22 thereby sealing the fill openings 32 and 34 leaving open the vent hole 28 in communication with the fill hole 30 in the top wall portion 22. Excess steam 42 is allowed to vent as indicated by the arrows 44 in FIG. 5.

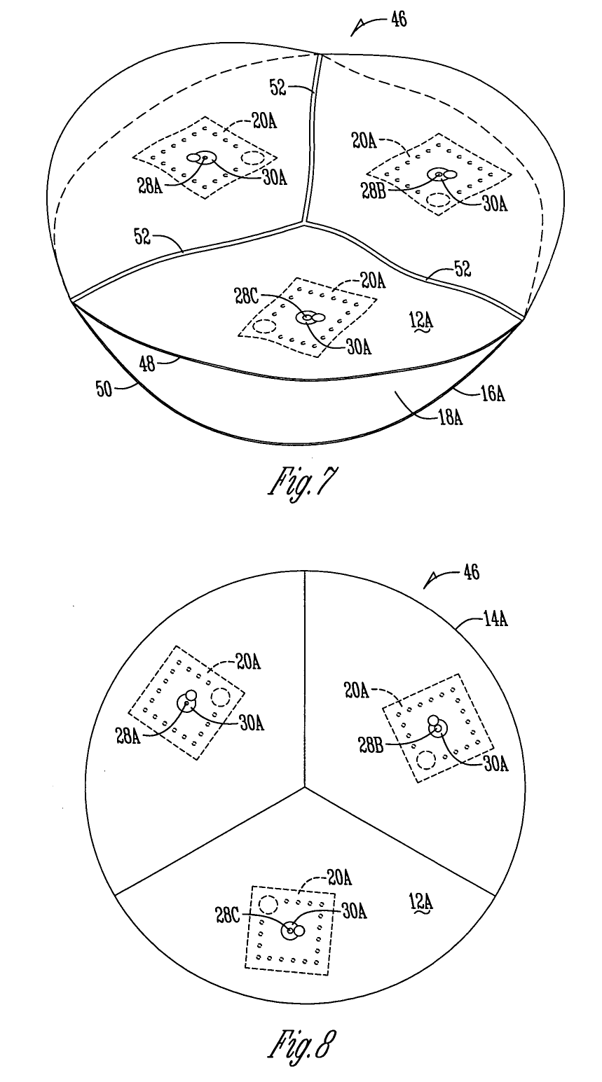

In FIGS. 7 and 8 a modified embodiment of the invention of FIGS. 1-6 is shown and is referred to generally by the reference numeral 46 and includes a top sheet 48 of film material secured to a bottom sheet of film material 50 along radial lines 52 creating individual food chambers 18A formed by individual top wall sheets 12A and 16A. The top wall sheets 12A include the patch or bottom wall portion of the top wall 20A.

The individual food chambers 18A upon being filled with food items by the grocer or the consumer, are sealed along their peripheral edges 14A. It is seen in FIGS. 7 and 8 that the vent holes 28A, 28B and 28C are progressively larger in size to allow for all food items to be cooked at the same time but with varying cooking pressures depending on the vent hole size. The smaller the vent hole 28 the larger the cooking pressure.

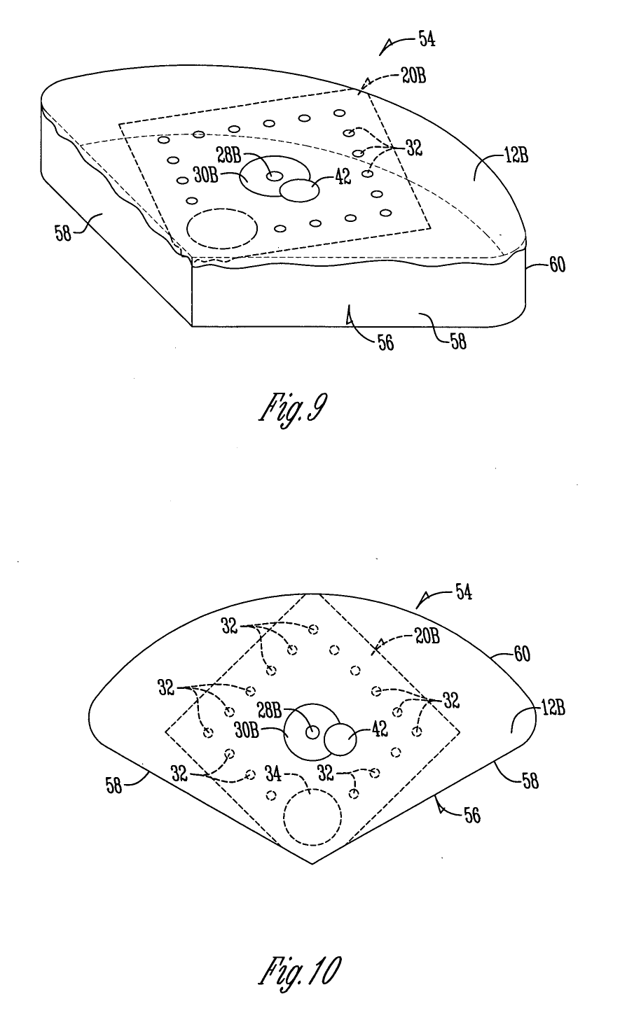

In FIGS. 9 and 10 the packaging concept of this invention is incorporated into an alternative embodiment referred to generally by the reference numeral 54 and includes a bottom wall comprising a tray 56 having side walls 58 and 60 configured to form a pie piece shaped tray. A top sheet of film material 12B is sealingly engaged along its peripheral edges to the top edges of the tray sidewalls 58 and 60. The patch or bottom wall portion 20B of the top wall is shown secured to the bottom side of the top wall of film material 12B. The patch 20B includes a vent hole 28B in communication with a fill hole 30B.

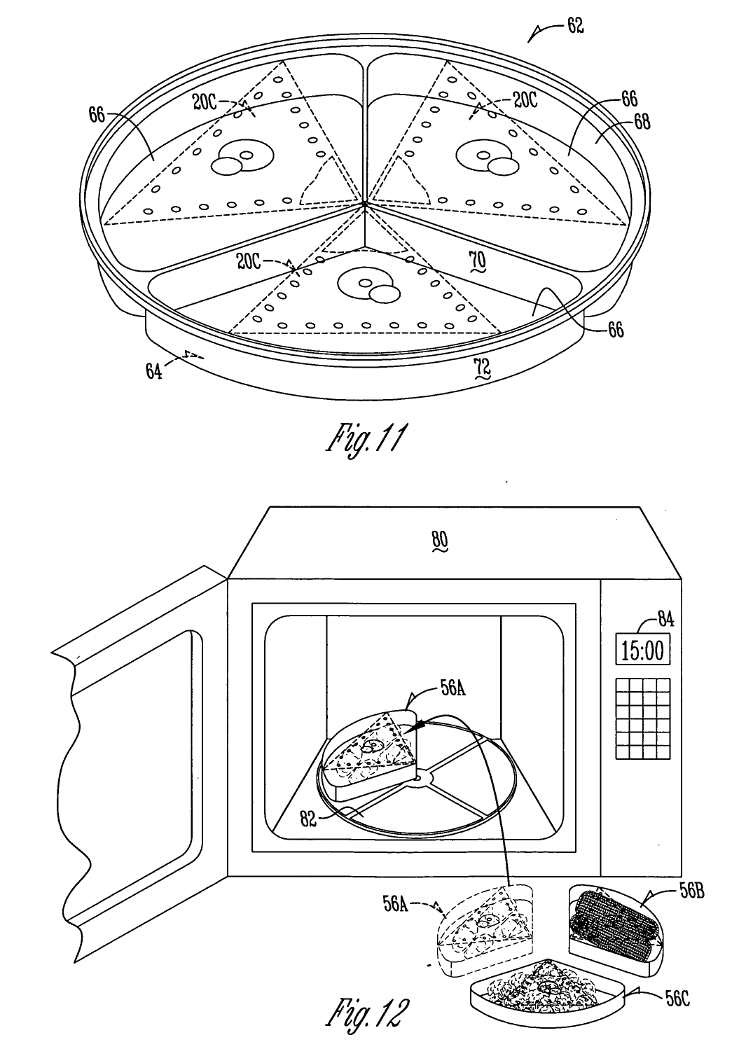

In FIG. 11 an alternative embodiment of the packaging concept of this invention is referred to generally by the reference numeral 62 and is comprised of a pie shaped tray 64 including pie piece shaped chambers 66 covered by top wall film sheets 68 including triangular shaped patches 20C. Different food items can be packaged and cooked appropriately as discussed with regards to the embodiment 46 shown in FIGS. 7 and 8. It is seen that the tray 64 includes radially extending walls 70 which cooperate with the peripheral circular wall 72 to create the chambers 66.

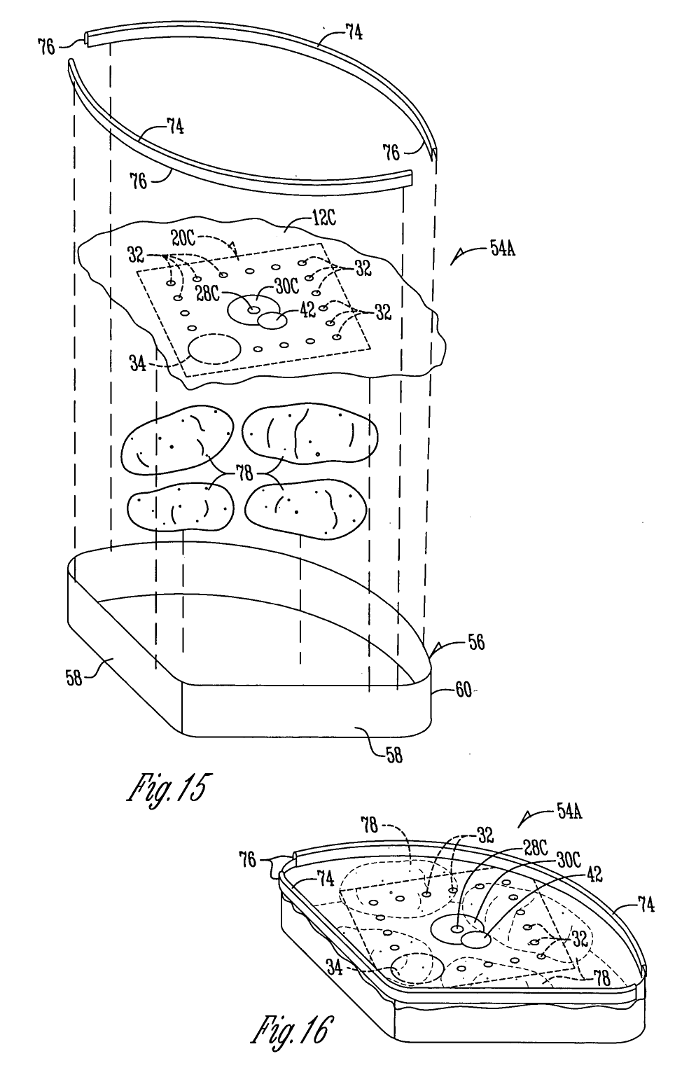

In FIGS. 15 and 16 is an alternative embodiment to that shown in FIGS. 9 and 10 and is referred to generally by the reference numeral 54A and includes the tray 56 to which a top sheet of film material 12C is attached by downwardly facing U-shaped clips 74 having legs 76 engaging the opposite faces of the tray side walls 58 and 60 as seen in FIG. 16. The patch 20C is of the same construction and functions in the same manner as previously described. By the way of example, potatoes 78 are seen being packaged in the embodiment 54A of FIGS. 15 and 16.

In FIGS. 12-14 a method of cooking is illustrated utilizing the packaging concept of this invention and a microwave 80 having a turn table 82.

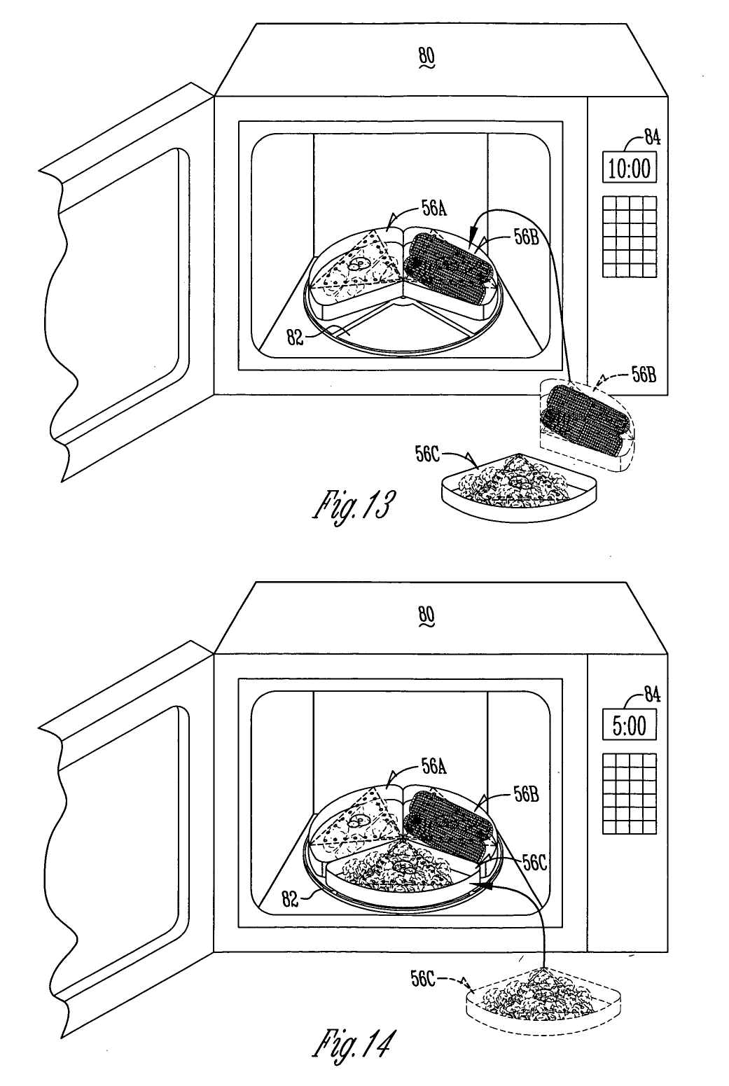

The food trays 56A, 56B and 56C are shown containing food items requiring different cooking times and thus the timer 84 on the microwave oven 80 is set at 15 minutes which is the cooking time for the food item in tray 56A. The tray 56A is first placed in the microwave oven on the turn table 82 and allowed to cook until 10 minutes shows on the timer as seen in FIG. 13 when the tray 56B is then placed in the oven 80 as its food item requires the second longest cooking time. The microwave cooking is restarted allowing the timer to count down to 5 minutes as shown in FIG. 14 whereupon the tray 56C is then placed in the microwave oven 80 as it requires only 5 minutes of cooking, the least amount of time for the three different food items. The microwave oven is restarted and allowed to cook until the timer 84 terminates the cooking when the full 15 minutes have expired. All food items will have been cooked precisely as has been determined is appropriate. Maintaining a record of information including microwave wattage, food item description, weight of item, liquid to be added, cooking vessel and time of cooking allows for consistent repeatability of successful cooking.

1. Food packaging for microwave pressure cooking, comprising:
packaging of sheet material having top and bottom walls forming a food chamber therebetween, and said top wall having a fill opening; and
a patch of sheet material being secured along its peripheral edge to said packaging top wall and forming a pocket therebetween, and a vent hole in said patch of sheet material adapted to communicate with said fill opening in said packaging top wall for release of from said food chamber a vapor at a predetermined pressure.

2. The food packaging of claim 1 wherein said patch sheet material includes at least one fill hole remote to said vent hole in said patch and said fill hole in said top wall of said packaging whereby vapor pressure in said food chamber during microwave cooking closes said fill hole in said patch by pressing said patch sheet material against said packaging top wall.

3. The food packaging of claim 2 wherein said fill hole in said patch sheet is one of a plurality of fill holes in said patch sheet all of which are positioned remote to said vent hole in said patch sheet and said fill hole in said packaging top wall whereby liquid and additives placed in said pocket through said packaging top wall fill hole pass through said patch fill holes into said food chamber during cooking preparation and are closed by vapor pressure during cooking as said patch sheet is pressed against said packaging top wall.

4. The food packaging of claim 3 wherein one of said fill holes in said patch sheet is substantially larger than said other patch sheet fill holes thereby being adapted to receive and pas relatively larger additives into said food chamber.

5. The food packaging of claim 1 and a tab is provided on said packaging top wall adjacent said fill hole and is adapted to be used for lifting said packaging top wall away from said patch sheet to form said pocket to receive liquid and additives passing through said pocket to said food chamber.

6. The food packaging for microwave pressure cooking, comprising;
packaging of sheet material having top and bottom walls forming a food chamber therebetween, said top wall including first and second parallel wall portions forming a pocket therebetween;
said first wall portion being above said second wall portion, and said first wall portion having a fill opening; and
said second wall portion having a vent hole adapted to communicate with said fill opening in said first wall portion for release of vapor from said food chamber at a predetermined pressure during cooking.

7. The food packaging of claim 6 wherein said lower second wall portion includes at lest one fill hole remote to said vent hole in said second wall portion and said fill hole in said top wall portion whereby vapor pressure in said food chamber during cooking closes said fill hole in said second lower wall portion by pressing said second wall portion against said top first wall portion.

8. The food packaging of claim 7 wherein said fill hole in said second lower wall portion is one of a plurality of fill holes in said second lower wall portion all of which are positioned remote to said vent hole in said second lower wall portion and said fill hole in said top first wall portion whereby liquid and additives placed in said pocket through said fill hole in said first top wall portion pass through said second bottom wall portion fill holes into said food chamber during cooking preparation and are closed by vapor pressure during cooking as said second bottom wall portions is pressed against said first top wall portion.

9. The food packaging of claim 8 wherein said one of said fill holes in said second bottom wall portion is substantially larger than said other second wall portion fill holes thereby being adapted to receive and pass relatively larger additives into said food chamber.

10. The food packaging of claim 6 and a tab is provided on said top first wall portion adjacent said fill hole and is adapted to be used for lifting said top first wall portion away from said bottom second wall portion to form said pocket to receive liquid and additives passing through said pocket to said food chamber.

11. The food packaging for microwave pressure cooking, comprising;
packaging having top and bottom walls forming a food chamber therebetween, said top wall being formed from sheet material and including first and second parallel wall portions forming a pocket therebetween;
said first wall portion being above said second wall portion, and said first wall portion having a fill opening; and
said second wall portion having a vent hole adapted to communicate with said fill opening in said first wall portion for release of vapor from said food chamber at a predetermined pressure during cooking.

12. The food packaging of claim 11 wherein said lower second wall portion includes at lest one fill hole remote to said vent hole in said second wall portion and said fill hole in said top wall portion whereby vapor pressure in said food chamber during cooking closes said fill hole in said second lower wall portion by pressing said second wall portion against said top first wall portion.

13. The food packaging of claim 12 wherein said fill hole in said second lower wall portion is one of a plurality of fill holes in said second lower wall portion all of which are positioned remote to said vent hole in said second lower wall portion and said fill hole in said top first wall portion whereby liquid and additives placed in said pocket through said fill hole in said first top wall portion pass through said second bottom wall portion fill holes into said food chamber during cooking preparation and are closed by vapor pressure during cooking as said second bottom wall portion is pressed against said first top wall portion.

14. The food packaging of claim 12 wherein said one of said fill holes in said second bottom wall portion is substantially larger than said other second wall portion fill holes thereby being adapted to receive and pass relatively larger additives into said food chamber.

15. The food packaging of claim 11 and a tab is provided on said top first wall portion adjacent said fill hole and is adapted to be used for lifting said top first wall portion away from said bottom second wall portion to form said pocket to receive liquid and additives passing through said pocket to said food chamber.

16. The food packaging for microwave pressure cooking, comprising;
packaging including top and bottom sheets sealingly interconnected along a plurality of radial lines to form a plurality of pie shaped food chambers; and
each of said food chambers being open at their outer peripheral edges and adapted to be sealingly closed to provide a plurality of substantially sealed food chambers.

17. The food packaging of claim 16 and a patch of sheet material is sealingly secured along its peripheral edges to said top sheet over each of said food chambers forming a separate pocket for each food chamber between a portion of the top sheet and the patch.

18. The food packaging of claim 17 wherein either the patch sheet or the top sheet portion of each food chamber may be positioned above the other to form pocket top and bottom walls, said pocket top walls each including a fill opening over a vent opening in said pocket bottom wall, at least one fill opening in said pocket bottom wall remotely positioned to said vent opening.

19. The food packaging of claim 18 wherein said fill opening in each of said pocket bottom walls is one of a plurality of fill openings in each of said pocket bottom walls whereby during cooling pressure in said food chambers cause said bottom pocket walls to rise and press against said pocket wall sealing said fill openings in said pocket bottom wall.

20. The food packaging of claim 11 wherein said bottom wall is the bottom wall of a tray having vertical side walls, said side walls having upper edges to which said top wall of sheet material is sealingly secured.

21. The food packaging of claim 20 wherein the sealing of said top wall of sheet material to the upper edges of said vertical tray walls is by adhesive.

22. The food packaging of claim 20 wherein the sealing of said top wall of sheet material to the upper edges of said vertical tray walls is by a clip, and said clip being U-shaped and downwardly facing includes oppositely disposed legs operatively engaging opposite sides of said tray vertical walls.

23. The food packaging of claim 20 wherein said vertical side walls of said tray form a three sided pie piece shaped tray.

24. The food packaging of claim 23 wherein said tray is one of a plurality of trays positioned in side by side relationship to form a circular pie of trays adapted to matingly fit on a circular tray in a microwave oven.

25. The food packaging of claim 20 wherein said tray is unitary and pie shaped and includes multiple pie piece shaped food chambers.

26. Method of microwave pressure cooking packaged food, comprising the stages of:
providing a plurality of pie piece shaped packages of food items requiring different cooking times and forming the shape of a pie when assembled together in a microwave oven;
setting the cooking time on the microwave oven to the time corresponding to the longest cooking time of any of the food items;
placing the food item requiring the longest cooking time in the microwave oven and starting the cooking timer;
stopping the timer and cooking when the time remaining corresponds to the cooking time for the food items requiring the next longest cooking time which is then placed in the microwave oven which is then restarted; and
repeating the preceding step until all food items are cooked and the set time on the oven timer has expired.
